(19) United States
(12) Patent Application Publication
(10) Pub. No.: US 2021/0249941 A1
(43) Pub. Date: Aug. 12, 2021

(54) LINEAR VIBRATION MOTOR WITH COMPOUND ELASTIC SYSTEM

(71) Applicant: TOPRAY MEMS INC., Hsinchu City (TW)

(72) Inventors: Chin-Sung Liu, Hsinchu City (TW); Shin-Ter Tsai, Hsinchu City (TW); Hsiao-Ming Chien, Hsinchu City (TW)

(21) Appl. No.: 16/809,953

(22) Filed: Mar. 5, 2020

(30) Foreign Application Priority Data
Feb. 11, 2020 (TW) 109104284

(51) Int. Cl. H02K 33/02

(52) U.S. Cl. CPC H02K 33/02

(57) ABSTRACT

A linear vibration motor with compound elastic system is disclosed, comprising: a movable portion, a suspension system, and a fixed portion; wherein the movable portion includes at least a magnet set, and the suspension system includes at least a support element and an elastic element, the fixed portion includes at least a coil set, a magnetically permeable element set, and a housing; the magnetically permeable element set includes at least a first magnetically permeable element set, disposed above or below the magnetic set; the magnetic set includes at least two magnets arranged spaced apart, with up-down magnetization direction and adjacent magnets of opposite polarities. The length of the magnet set is greater than the length of the first magnetically permeable element set. The elastic element and the magnetic restoring force between the magnet set and the magnetically permeable element set constitute a compound elastic system.

### CROSS-REFERENCE TO RELATED APPLICATION

This application claims the priority of Taiwanese patent application No. 109104284, filed on Feb. 11, 2020, which is incorporated herewith by reference.

### BACKGROUND OF THE INVENTION

### 1. Field of the Invention

The present invention relates generally to a linear vibration motor with compound elastic system.

### 2. The Prior Arts

With the popularity of smart mobile devices, such as mobile phones and wearable devices, the linear vibration motors have become the mainstream actuators of the touch feedback. In addition, due to the thinning of mobile devices, the specifications of linear vibration motors are receiving increasing attention. The linear vibration motor is mainly used to provide feedback or other necessary reminder functions for the user when the device operates through vibration. Therefore, the vibration mode or the fineness of the vibration greatly affects the touch and feel of user's hand, which in turn affects the overall use experience regarding smart mobile devices.

The structure of the traditional linear vibration motor basically consists of a movable portion, a fixed portion, and a suspension system; for example, in the most simplified embodiment, the movable part may be a magnet set, the fixed part may be a coil set, and the suspension system may be a spring set. In other words, the structure of the linear vibration motor determines the vibration mode as: the magnet set controlled by the coil set and moving linearly relative to the coil set to reach the resonance frequency. In addition, in a linear vibration motor, at least one magnetically permeable element is often provided in the fixed portion to improve the vibration effect thereof.

### SUMMARY OF THE INVENTION

An embodiment of the present invention provides a linear vibration motor with compound elastic system, comprising: a movable portion, a suspension system, and a fixed portion; wherein the movable portion comprises at least a magnet set, and the suspension system comprises at least a support element and an elastic element, the fixed portion comprises at least a coil set, a magnetically permeable element set, and a housing; the magnetically permeable element set comprises at least a first magnetically permeable element set, disposed above or below the magnetic set; the magnetic set comprises at least two magnets arranged spaced apart, with up-down magnetization direction and adjacent magnets having opposite polarities; the magnet set has a total length greater than a total length of the first magnetically permeable element set; and the elastic element and a magnetic restoring force formed between the magnet set and the magnetically permeable element set constitute the compound elastic system.

In a preferred embodiment of the present invention, the magnetically permeable element set further comprises a second magnetically permeable element set, the second magnetically permeable element set has the same composition as the first magnetically permeable element set, and is disposed symmetrically with the first magnetically permeable element set above and below the magnet set.

In a preferred embodiment of the present invention, the magnetically permeable element set further comprises a second magnetically permeable element set, the second magnetically permeable element set has a different composition from the first magnetically permeable element set, and is disposed opposite to the first magnetically permeable element set above and below the magnet set, respectively.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic view of the fixed portion of the linear vibration motor according to an embodiment of the present invention;

FIG. 2 is a schematic view of the near-closed magnetic circuit formed between the magnetically permeable element set and the magnet set according to an embodiment of the present invention;

FIG. 3A is a schematic view of the stress on the suspension system of the linear vibration motor according to an embodiment of the present invention;

FIG. 3B is a schematic view of the restoration force of the suspension system of the linear vibration motor according to an embodiment of the present invention;

FIG. 4 is a schematic view of the layout of the magnetically permeable element set and the magnet set of the compound elastic system of the linear vibration motor according to a first embodiment of the present invention;

FIG. 5 is a schematic view of the relation between the magnetic restoration force and the displacement distance of the end surface of the magnet;

FIG. 6 is a schematic view of the layout of the magnetically permeable element set and the magnet set of the compound elastic system of the linear vibration motor according to a second embodiment of the present invention; and

FIG. 7 is a schematic view of the layout of the magnetically permeable element set and the magnet set of the compound elastic system of the linear vibration motor according to a third embodiment of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

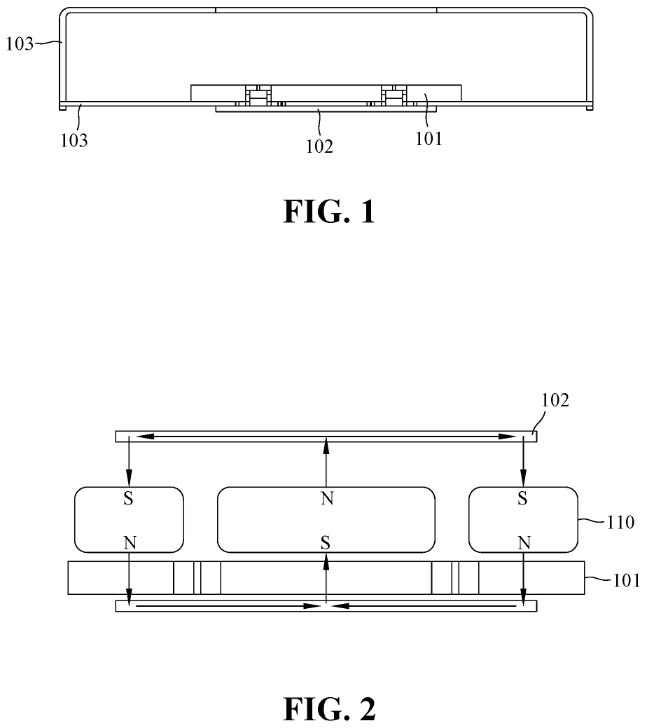

Referring to FIG. 1, FIG. 1 is a schematic view of the fixed portion of the linear vibration motor according to an embodiment of the present invention. As shown in FIG. 1, the linear vibration motor with compound elastic system of the present invention comprises: a movable portion, a suspension system, and a fixed portion. The movable portion comprises at least a magnet set, and the suspension system comprises at least a support element and an elastic element, the fixed portion comprises at least a coil set 101, a magnetically permeable element set 102, and a housing 103.

It is worth noting that, as shown in FIG. 2, during vibration, the magnetically permeable element set 102 is located on the side of the coil set 101 far from the magnet set 110 of the movable portion, and the magnetically permeable element set 102 and the magnetic set 110 form an approximately closed magnetic circuit. A Lorentz force is generated by the magnet set 110 of the movable portion when a current is applied to the coil unit 101. The Lorentz force causes the movable portion and the suspension system to move, i.e., a displacement is generated. The main technical feature of the present invention is to apply the displacement generated by Lorentz force to a compound elastic system composed of the suspension system and the magnetic restoration force generated by the closed magnetic circuit to reduce the fatigue damage of the elastic element.

The main operation principles are explained as follows:

As described earlier, the suspension system comprises at least a support element and an elastic element. The support element and the elastic element regulate the movement direction and displacement restoration force of the movable part; wherein, the elastic constant (Ks) of the elastic element will be determined according to the design requirement of the resonance frequency of the linear vibration motor. Under the conditions of the same suspension system, the elastic constant is proportional to the stress caused by the force applied to the suspension system. For example, the higher the resonance frequency of the linear vibration motor (under the condition that other design component parameters are the same) is, the higher the stress of the elastic element will be. In other words, the higher the stress, the faster the elastic element will be damaged due to material fatigue under the same repetitive motions.

Due to the aforementioned material fatigue issue, the present invention further adds an extra force with a elastic constant (Km) to the suspension system to form the compound elastic system of the linear vibration motor to reduce the elastic constant (Ks′) required for the elastic element of the suspension system. In other words, Ks=Ks′+Km, so that Ks′<Ks, which achieves the effect of reducing the magnitude of the stress experienced by the elastic element, thereby reducing the fatigue damage of the elastic element.

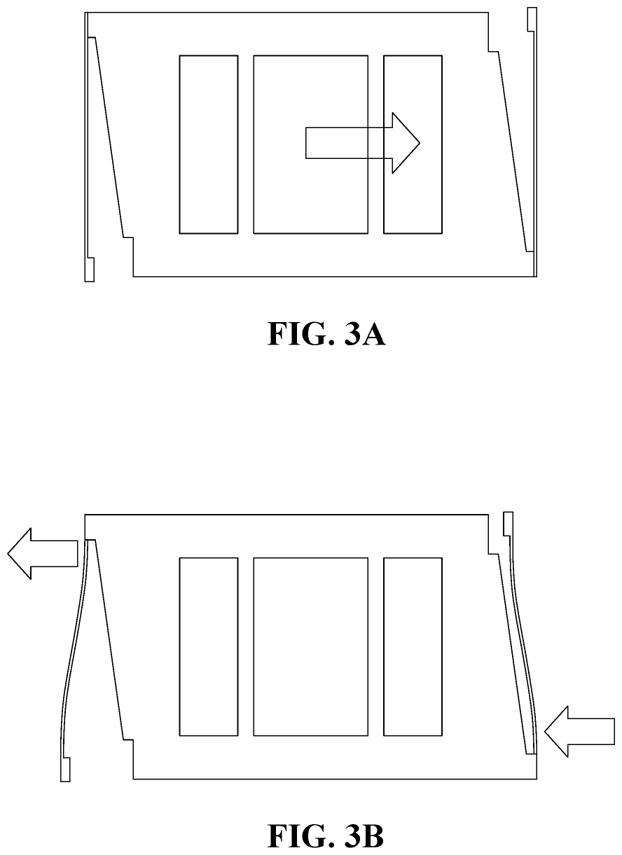

FIG. 3A is a schematic view of the stress on the suspension system of the linear vibration motor according to an embodiment of the present invention; and FIG. 3B is a schematic view of the restoration force of the suspension system of the linear vibration motor according to an embodiment of the present invention. As shown in FIGS. 3A and 3B, since the use of magnetic permeable element has the effect of guiding to increase the magnetic lines of the magnet set 110 through the effective area of the coil set 101 to increase the Lorentz force, or using the magnetic permeable element and the magnet set to form an approximately closed magnetic circuit so as to provide a magnetic restoration force of the movable portion with respect to the fixed portion when the movable portion is displaced, so that the movable portion returns to its mechanical origin. The direction of the arrow in the figures represents the direction of the force.

Therefore, when the distance between the end faces of the magnetically permeable element set and the magnet set is aligned (d=0), the magnetic restoration force provided by the magnetically permeable element of the fixed portion to the magnetic set of the movable portion is zero; when the magnet set 110 of the movable portion is displaced to the right, the right end surface of the magnet set and the right end surface of the magnetic permeable element, because of the magnetic attraction caused by the magnetic field, will cause the magnet set of the movable portion to experience a restoration force for leftward movement. When displaced to the left, the restoration force provides the corresponding resilience in the opposite direction, i.e., to the right.

Hence, the present invention, through the disposition of the magnetically permeable element set of the fixed portion and regulating the specific disposition conditions, uses the aforementioned magnetic restoration force formed by the magnetically permeable element set and the magnetic set as the force with a elastic constant (Km) in addition to the suspension system. As a result, the compound elastic system of the linear vibration motor of the present invention does not need to rely entirely on the elastic elements of the suspension system to bear the repetitive motions.

In other words, the compound elastic system of the linear vibration motor of the present invention will be composed of the elastic elements of the suspension system and the magnetic restoration force formed by the disposition of the magnetically permeable element set and the magnet set under specific conditions, so that the above Ks=Ks′+Km conditions are established. Once Ks′<Ks, the objective of reducing the required elastic constant of the elastic elements of the suspension system is achieved, so that the stress on the elastic element during the repetitive motion is reduced, thereby reducing the possible fatigue damage on the elastic elements.

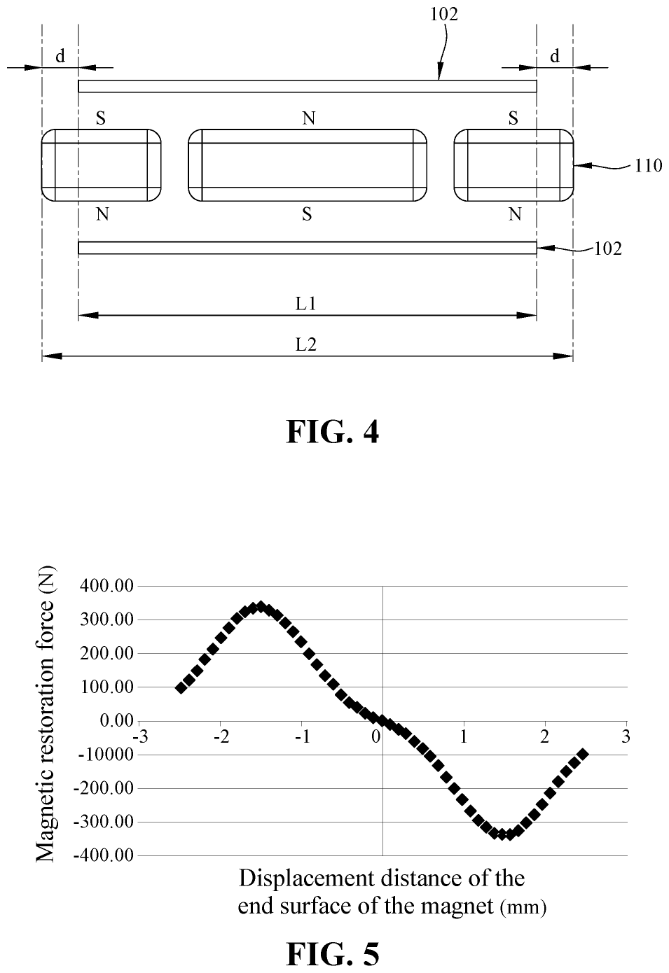

FIG. 4 is a schematic view of a first embodiment of a magnetically permeable element set and a magnet set of the compound elastic system of the linear vibration motor of the present invention. As shown in FIG. 4, the magnetically permeable element set 102 comprises an upper magnetically permeable element and a lower magnetically permeable element; wherein the upper magnetically permeable element is the same as the lower magnetically permeable element and has a length L1; the magnetic set 110 comprises at least two magnets arranged in a spaced manner, and the magnetization direction of the magnets is in the up-down direction (i.e., vertically in the figure), and the adjacent magnets have opposite polarities when disposed. The total length (including the gap) of the magnet set 110 is L2. For example, as shown in FIG. 4, the magnet set 110 comprises three magnets, of which the leftmost magnet has the S pole at the top and N pole at the bottom; the middle magnet has the N pole at the top and S pole at the bottom; the rightmost magnet has the S pole at the top and N pole at the bottom. When the magnet set 110 comprises more magnets, the arrangement is similar. As shown in FIG. 4, the total length from the left end of the leftmost magnet to the right end of the rightmost magnet is L2, and the distances between the two end surfaces of the magnetic permeable element set 102 and the two end surfaces of the magnet set 110 are both d. L1 L2, and the magnetic restoration force formed is a function of the distance d. FIG. 5 is a schematic view showing the relation between the magnetic restoration force and the displacement distance of the end surface of the magnet.

In other words, during the vibration, the compound elastic system of the linear vibration motor of the present invention shares the force (F) received when the movable part is displaced by the restoration force f1 of the elastic element of the suspension system and the aforementioned magnetic restoration force f2, that is, F=Ks*x=f1+f2=Ks′*x+f (x), where x is the displacement distance during vibration. Because f1<F, Ks′<Ks; therefore, the elastic constant (Ks′) of the elastic element of the suspension system is less than the original elastic constant (Ks) of the elastic element of the suspension system required when the magnetic restoration force is not present. By reducing the elastic constant to reduce the stress of the elastic element of the suspension device, the present invention thereby reduces the fatigue damage suffered by the elastic element.

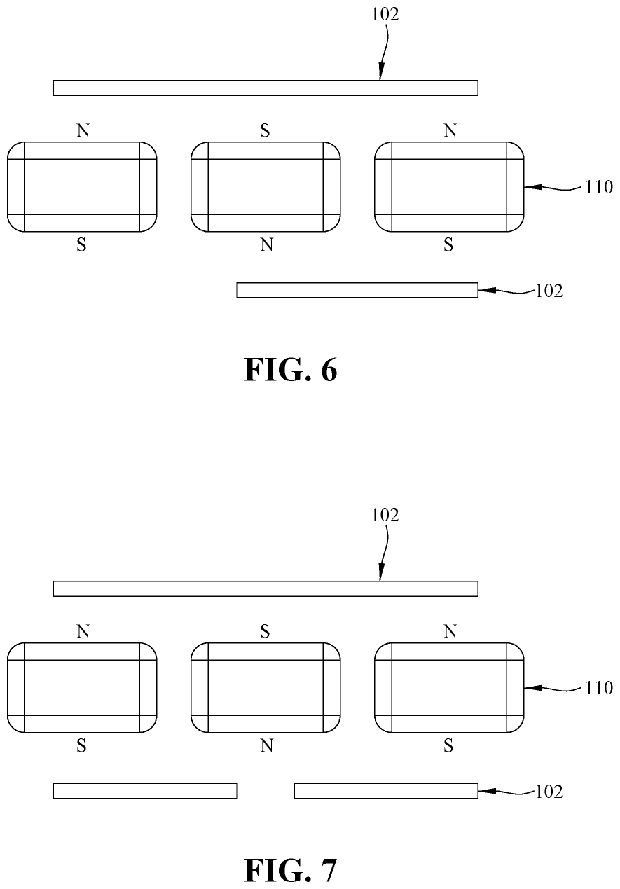

FIG. 6 is a schematic view of a second embodiment of a magnetically permeable element set and a magnet set of the compound elastic system of the linear vibration motor of the present invention. The difference between the present embodiment and the first embodiment is that the magnetically permeable element set 102 comprises an upper magnetically permeable element and a lower magnetically permeable element; the length of the upper magnetically permeable element is different from that of the lower magnetically permeable element. As shown in FIG. 6, in the present embodiment, the length of the upper magnetically permeable element is long enough to correspond to all the magnets in the magnetic set 110, and the lower magnetically permeable element only corresponds to the middle magnet and the rightmost magnet in the magnetic set 110.

FIG. 7 is a schematic view of a third embodiment of a magnetically permeable element set and a magnet set of the compound elastic system of the linear vibration motor of the present invention. The difference between the present embodiment and the second embodiment is that the magnetically permeable element set 102 comprises an upper magnetically permeable element and two lower magnetically permeable elements; the length of the upper magnetically permeable element is different from that of the two lower magnetically permeable elements. As shown in FIG. 7, in the present embodiment, the length of the upper magnetically permeable element is long enough to correspond to all the magnets in the magnetic set 110, and the lower magnetically permeable element on the left only corresponds to the middle magnet and the leftmost magnet in the magnetic set 110, while the lower magnetically permeable element on the left only corresponds to the middle magnet and the rightmost magnet in the magnetic set 110.

In other words, the composition and arrangement of magnetically permeable element sets can be designed to correspond to different magnets in the magnetic set.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A linear vibration motor with compound elastic system, comprising:
a movable portion, a suspension system, and a fixed portion;
wherein the movable portion comprising at least a magnet set;
the suspension system comprising at least a support element and an elastic element;
the fixed portion comprising at least a coil set, a magnetically permeable element set, and a housing;
the magnetically permeable element set comprising at least a first magnetically permeable element set, disposed above or below the magnetic set;
the magnetic set comprising at least two magnets arranged spaced apart, with up-down magnetization direction and adjacent magnets having opposite polarities;
the magnet set having a total length greater than a total length of the first magnetically permeable element set; and
the elastic element and a magnetic restoring force formed between the magnet set and the magnetically permeable element set constituting the compound elastic system.

2. The linear vibration motor with compound elastic system according to claim 1, wherein the magnetically permeable element set further comprises a second magnetically permeable element set, the second magnetically permeable element set has the same composition as the first magnetically permeable element set, and is disposed symmetrically with the first magnetically permeable element set above and below the magnet set.

3. The linear vibration motor with compound elastic system according to claim 1, wherein the magnetically permeable element set further comprises a second magnetically permeable element set, the second magnetically permeable element set has a different composition from the first magnetically permeable element set, and is disposed opposite to the first magnetically permeable element set above and below the magnet set, respectively.
